(19) United States
(12) Patent Application Publication
(10) Pub. No.: US 2020/0404357 A1
(43) Pub. Date: Dec. 24, 2020

(54) Electrical Device Control Using Passive Tags

(71) Applicant: SIGNIFY HOLDING B.V., EINDHOVEN (NL)

(72) Inventors: Ajinkya Kulkarni, Dhule (IN); Ashok Gundumalla, Rajahmundry (IN)

(21) Appl. No.: 16/450,220

(22) Filed: Jun. 24, 2019

(51) Int. Cl. H04N 21/422; G06K 7/10; H04L 29/12; H04W 4/80; G06F 3/01

(52) U.S. Cl. CPC H04N 21/42204; G06K 7/10237; G06F 3/017; H04W 4/80; H04L 61/6081

(57) ABSTRACT

A passive tag for communication can include a passive array having an antenna assembly and at least one resonator coupled to the antenna assembly. The passive tag can also include a body that covers the passive array, where the body includes at least one touch point, where each of the at least one touch point corresponds to one of the at least one resonators of the passive array. The body and the passive array can be without a power source and a transistor. The passive array can be configured to receive a first communication signal. The passive array can further be configured to backscatter a second communication signal using the first communication signal.

### TECHNICAL FIELD

Embodiments described herein relate generally to controlling electrical devices in a space, and more particularly to systems, methods, and devices for using passive tags to control electrical devices.

### BACKGROUND

Remote devices are commonly used to control electrical devices. For example, a hand-held wireless remote control can be used to turn a television on and off, change the channel, and adjust the volume. As another example, a wall switch can be used to turn a light fixture on and off, and also to change the dimming level of the light fixture. These remote devices that are used to control an electrical device require power, whether from a live circuit (e.g., AC mains power) or a battery.

### SUMMARY

In general, in one aspect, the disclosure relates to a passive tag for communications. The passive tag can include a passive array having an antenna assembly and at least one resonator coupled to the antenna assembly. The passive tag can also include a body that covers the passive array, the body having at least one touch point, where each of the at least one touch point corresponds to one of the at least one resonators of the passive array. The body and the passive array can be without a power source and a transistor. The passive array can be configured to receive a first communication signal. The passive array can be further configured to backscatter a second communication signal using the first communication signal.

In another aspect, the disclosure can generally relate to a system that includes a first electrical device having a first controller, the first controller having a transmitter for sending a first communication signal generated by the first controller. The system can also include a passive tag having a passive array and a body, the passive array having an antenna assembly and a first resonator coupled to the antenna assembly, the body covering the passive array, the body comprising a first touch point, where the first touch point corresponds to the first resonator of the passive array. The passive tag can be without a power source and a transistor. The passive array can receive the first communication signal. The passive array can backscatter a second communication signal using the first communication signal.

These and other aspects, objects, features, and embodiments will be apparent from the following description and the appended claims.

### BRIEF DESCRIPTION OF THE DRAWINGS

The drawings illustrate only example embodiments of electrical device control using passive tags and are therefore not to be considered limiting of its scope, as electrical device control using passive tags may admit to other equally effective embodiments. The elements and features shown in the drawings are not necessarily to scale, emphasis instead being placed upon clearly illustrating the principles of the example embodiments. Additionally, certain dimensions or positioning may be exaggerated to help visually convey such principles. In the drawings, reference numerals designate like or corresponding, but not necessarily identical, elements.

FIG. 1 shows a diagram of a system in accordance with certain example embodiments.

FIG. 2 shows a computing device in accordance with certain example embodiments.

FIG. 3 shows a diagram of another system in accordance with certain example embodiments.

FIG. 4 shows a lighting system in a healthcare environment in accordance with certain example embodiments.

FIG. 5 shows a lighting system in a manufacturing environment in accordance with certain example embodiments.

FIGS. 6A and 6B show a side and top view, respectively, of a system in which a tag is located in a volume of space in accordance with certain example embodiments.

FIG. 7 shows the system of FIGS. 6A and 6B when a signal is sent by one of the light fixtures in accordance with certain example embodiments.

FIG. 8 shows the system of FIGS. 6A through 7 when a signal is sent by the object in accordance with certain example embodiments.

FIGS. 9A and 9B show a passive tag in accordance with certain example embodiments.

FIG. 10A shows part of a system in accordance with certain example embodiments.

FIG. 10B shows a graph of the communication signals transmitted by the passive tag of FIG. 10A.

FIG. 11 shows a diagram of a system in accordance with certain example embodiments.

FIG. 12 shows a diagram of another system in accordance with certain example embodiments.

FIG. 13 shows a cross-section of a finger of a user.

FIG. 14 shows an interaction between a finger of a user and a passive array of a tag with a bistatic architecture in accordance with certain example embodiments.

FIG. 15 shows an interaction between a finger of a user and a passive array of a tag with a unistatic architecture in accordance with certain example embodiments.

### DETAILED DESCRIPTION OF EXAMPLE EMBODIMENTS

The example embodiments discussed herein are directed to systems, methods, and devices for controlling electrical devices using passive tags. While example embodiments are described herein as controlling one or more light fixtures using passive tags, example embodiments of passive tags can control one or more of a number of other electrical devices in addition to, or as an alternative to, light fixtures. Such other electrical devices can include, but are not limited to, a light switch, a control panel, a thermostat, an electrical wall outlet, a sensor device (e.g., a smoke detector, a CO₂ monitor, a motion detector, a broken glass sensor), an integrated sensor device (defined below), and a camera.

Example embodiments can be used in a volume of space having any size and/or located in any environment (e.g., indoor, outdoor, hazardous, non-hazardous, high humidity, low temperature, corrosive, sterile, high vibration). Further, communication signals described herein can be any of a number of types of signals using any of a number of different platforms, including but not limited to radio frequency (RF) signals, visible light signals, LiFi, WiFi, Bluetooth, Bluetooth Low Energy (BLE), Zigbee, RFID, ultraviolet waves, microwaves, and infrared signals. For example, RF signals transmitted using BLE are sent and received at approximately 2.4 GHz.

When an electrical device in an example system is a light fixture (also called a luminaire), the light fixture can be any of a number of types of light fixtures, including but not limited to a troffer, a pendant light fixture, a floodlight, a spotlight, an emergency egress fixture, an exit sign, a down can light fixture, and a high bay light fixture. Regardless of the type of light fixture, such a light fixture can use one or more of a number of different types of light sources, including but not limited to light-emitting diode (LED) light sources, fluorescent light sources, organic LED light sources, incandescent light sources, and halogen light sources. Therefore, light fixtures described herein, even in hazardous locations, should not be considered limited to a particular type and/or using a particular kind of light source.

Example embodiments can provide a high level of data security if such security is desired by a user. Example embodiments can use low amounts of power on demand. Example embodiments can be installed with new electrical (e.g., lighting, security, entertainment, HVAC) systems. Alternatively, example embodiments can be integrated with existing electrical systems and related equipment with little to no need to add or modify existing hardware.

In certain example embodiments, systems (or portions thereof) that control electrical devices using passive tags are subject to meeting certain standards and/or requirements. For example, the National Electric Code (NEC), the National Electrical Manufacturers Association (NEMA), the International Electrotechnical Commission (IEC), the Federal Communication Commission (FCC), and the Institute of Electrical and Electronics Engineers (IEEE) set standards as to electrical enclosures (e.g., light fixtures), wiring, and electrical connections. Use of example embodiments described herein meet (and/or allow a corresponding device to meet) such standards when required. In some (e.g., PV solar) applications, additional standards particular to that application may be met by the electrical enclosures described herein.

If a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. The numbering scheme for the various components in the figures herein is such that each component is a three-digit number or a four-digit number, and corresponding components in other figures have the identical last two digits. For any figure shown and described herein, one or more of the components may be omitted, added, repeated, and/or substituted. Accordingly, embodiments shown in a particular figure should not be considered limited to the specific arrangements of components shown in such figure.

Further, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of controlling electrical devices using passive tags will be described more fully hereinafter with reference to the accompanying drawings, in which example embodiments of controlling electrical devices using passive tags are shown. Controlling electrical devices using passive tags may, however, be embodied in many different forms and should not be construed as limited to the example embodiments set forth herein. Rather, these example embodiments are provided so that this disclosure will be thorough and complete, and will fully convey the scope of controlling electrical devices using passive tags to those or ordinary skill in the art. Like, but not necessarily the same, elements (also sometimes called components) in the various figures are denoted by like reference numerals for consistency.

Terms such as “first”, “second”, and “within” are used merely to distinguish one component (or part of a component or state of a component) from another. Such terms are not meant to denote a preference or a particular orientation, and such terms are not meant to limit embodiments of controlling electrical devices using passive tags. In the following detailed description of the example embodiments, numerous specific details are set forth in order to provide a more thorough understanding of the invention. However, it will be apparent to one of ordinary skill in the art that the invention may be practiced without these specific details. In other instances, well-known features may not have not been described in detail to avoid unnecessarily complicating the description.

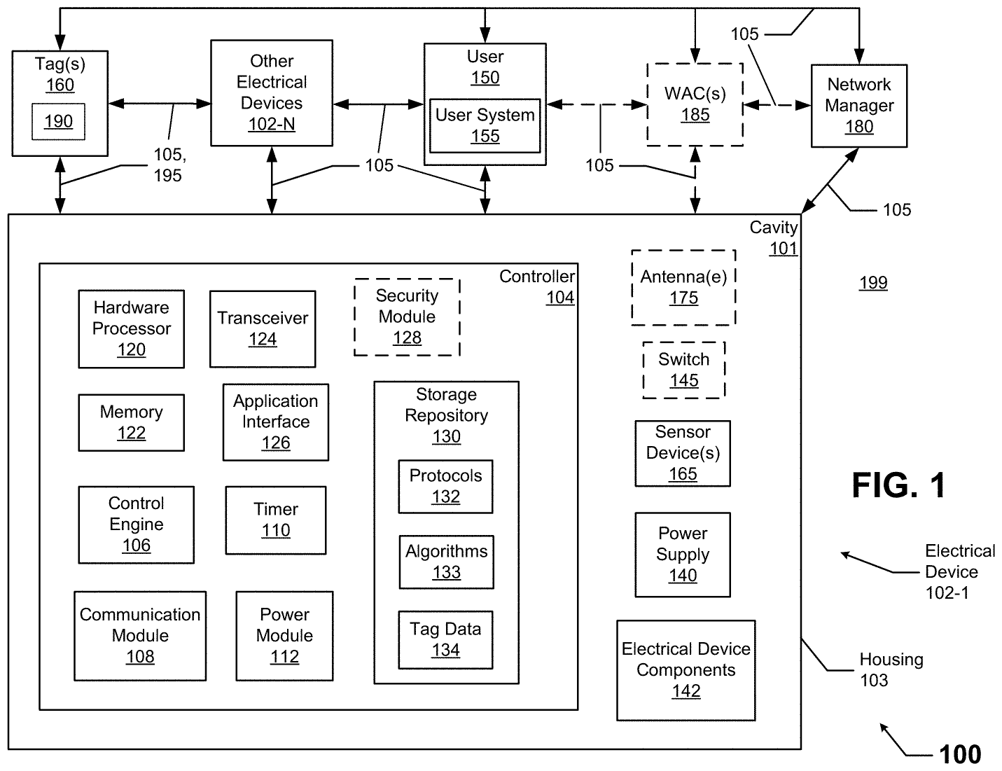

FIG. 1 shows a diagram of a system 100 that includes multiple electrical devices 102 and one or more tags 160 in a volume of space 199 in accordance with certain example embodiments. The system 100 can also include a user 150, a network manager 180, and one or more optional wireless access controllers 185 (WACs 185). Each electrical device 102 (e.g., electrical device 102-1) can include a controller 104, one or more sensor devices 165, one or more optional antennae 175, an optional switch 145, a power supply 140, and a number of electrical device components 142. The controller 104 can include one or more of a number of components. Such components, can include, but are not limited to, a control engine 106, a communication module 108, a timer 110, a power module 112, a storage repository 130, a hardware processor 120, a memory 122, a transceiver 124, an application interface 126, and, optionally, a security module 128. Each example tag 160 can include one or more passive arrays 190.

The components shown in FIG. 1 are not exhaustive, and in some embodiments, one or more of the components shown in FIG. 1 may not be included in an example electrical device 102. Any component of the example electrical device 102 can be discrete or combined with one or more other components of the electrical device 102. For example, each electrical device 102 in the system 100 can have its own controller 104. Alternatively, one controller 104 can be used to control multiple electrical devices 102 in the system. An electrical device 102 is any device that uses electricity, at least in part, to operate. A list of some potential electrical devices 102 is described above.

A user 150 may be any person that interacts with an electrical device 102 and/or a tag 160 in the volume of space 199. Specifically, a user 150 may program, operate, and/or interface with one or more components (e.g., a controller, a network manager) associated with the system 100 using example embodiments. Examples of a user 150 can include, but are not limited to, an employee, an engineer, an electrician, a technician, an operator, a consultant, a contractor, an asset, a network manager, and a manufacturer's representative.

The user 150 can include a user system 155, which may include a display (e.g., a GUI). A user system 155 can be any device (e.g., a smart phone, a laptop computer) that is capable of communicating with at least one other component of the system 100. In some cases, a user system 155 can be considered an electrical device 102. The user 150 (including a user system 155) can interact with (e.g., sends data to, receives data from) the controller 104 of an electrical device 102 via the application interface 126 (described below). The user 150 (including a user system 155) can also interact with a network manager 180, the sensor devices 165, and/or one or more of the tags 160. Interaction (including transmission of communication signals 195) between the user 150 (including a user system 155), the electrical devices 102, the network manager 180, the sensor devices 165, and the tags 160 can be facilitated using communication links 105.

Each communication link 105 can include wired (e.g., Class 1 electrical cables, Class 2 electrical cables, electrical connectors) and/or wireless (e.g., Wi-Fi, visible light communication, cellular networking, Bluetooth, Bluetooth Low Energy (BLE), Zigbee, WirelessHART, ISA100, Power Line Carrier, RS485, DALI) technology. For example, a communication link 105 can be (or include) one or more electrical conductors that are coupled to the housing 103 of an electrical device 102 and to the network manager 180. The communication links 105 can transmit signals (e.g., power signals, communication signals, communication signals 195, control signals, data) between the electrical devices 102, a user 150 (including a user system 155), the sensor devices 165, the tags 160, and/or the network manager 180. For example, the electrical devices 102 of the system 100 can interact with the one or more tags 160 by transmitting communication signals 195 (e.g., RF signals) over one or more communication links 105, as discussed below. The signals transmitted over the communication links 105 are made up of bits of data.

The network manager 180 is a device or component that controls all or a portion of the system 100 that includes the controller 104 of at least one of the electrical devices 102 and the optional WACs 185. The network manager 180 can be substantially similar to the controller 104 and/or an optional WAC 185. Alternatively, the network manager 180 can include one or more of a number of features in addition to, or altered from, the features of the controller 104 and/or a WAC 185, both described below. There can be more than one network manager 180 and/or one or more portions of a network manager 180.

Each optional WAC 185 (sometimes more simply called an access controller, as a generic term and/or when wired communication links 105 are involved) performs a number of different functions. For example, an optional WAC 185 can help communicate with and control the controller 104 of one or more electrical devices 102 to help control the operation of those electrical devices 102. The WAC 185 can be responsible for pairing with communication devices (e.g., a sensor device 165, the transceiver 124, a passive tag 190), providing configuration data to those communication devices, synchronizing the timing of those communication devices, supporting the firmware of those communication devices, upgrading those communication devices, receiving location/telemetry data (e.g., using a Zigbee-enabled communication links 105) from those communication devices, and/or performing any other function with respect to those communication devices to support control activities.

When a WAC 185 receives data (e.g., packed egress data that arrives as ingress data) from a sensor device 165, the WAC 185 can convert the data into a different format (e.g., ECAPI). The WAC 185 can then send the newly-formatted data to the network manager 180. To help diagnose issues, a WAC 185 can maintain counters for each paired electrical device 102 (or portion thereof) and include, for example, the number of received packed data messages from a particular electrical device 102, the number of formatted messages successfully transmitted to the network manager 180 that pertain to the packed data from a particular electrical device 102, and the number of formatted messages pertaining to the packed data from a particular electrical device 102 that failed to transmit to the network manager 180.

In some cases, a WAC 185 maintains the average and maximum latency introduced between the receipt of a message from an electrical device 102 and transmission of a formatted message to the network manager 180. The WAC 185 can also notify the network manager 180 when the average or maximum latency exceeds a threshold value. Further, a WAC 185 can communicate to the network manager 180 when there is a significant discrepancy (e.g., as determined by the WAC 185) between the ingress and egress packets with respect to an electrical device 102. When there are multiple WACs 185, they can all be time-synchronized with each other. In some cases, the functionality of a WAC 185 can be the same as, or at least partially combined with, the functionality of the controller 104 of an electrical device 102. A WAC 185 can be located in the volume of space 199 or remotely from the volume of space 199.

As defined herein, a tag 160 can be a platform or other medium on which communications with a transceiver 124 and/or a sensor device 165 of an electrical device 102 can be transmitted. Examples of such a platform or other medium can include, but are not limited to, a piece of paper, a decal, an employee ID card, a wall plate cover, and a patch. A tag 160 can be affixed to some object (e.g., a wall, a door, a piece of clothing, an arm, a file cabinet) using an adhesive, an elastic band, a fastening device (e.g., a screw, a rivet), and/or any other type of coupling feature. A tag 160 can be placed at a location in a volume of space 199 that is accessible to a user 150. A system 100 can have one tag 160 or multiple tags 160 in the volume of space 199.

Each tag 160 can include a passive array 190, which provides the communication capability of the tag 160. The passive array 190 can include one or more of a number of components. Examples of such components can include, but are not limited to, an antenna, a resonator, an inductor, and a shield. In certain example embodiments, the passive array 190 does not include certain components, including but not limited to a power source (e.g., a battery, a direct power feed) and a traditional communication module (e.g., a Bluetooth chip or other type of chip that is similar to the communication module 108 discussed below). Lacking such components is what makes the passive array 190 a passive component.

In certain example embodiments, the passive array 190 can receive one or more communication signals 195 (e.g., RF signals), alter the communication signal 195 based on interaction of the passive array 190 by a user 150, and broadcast the resulting altered communication signals 195, which can be received by any electrical devices 102 within range of the broadcast.

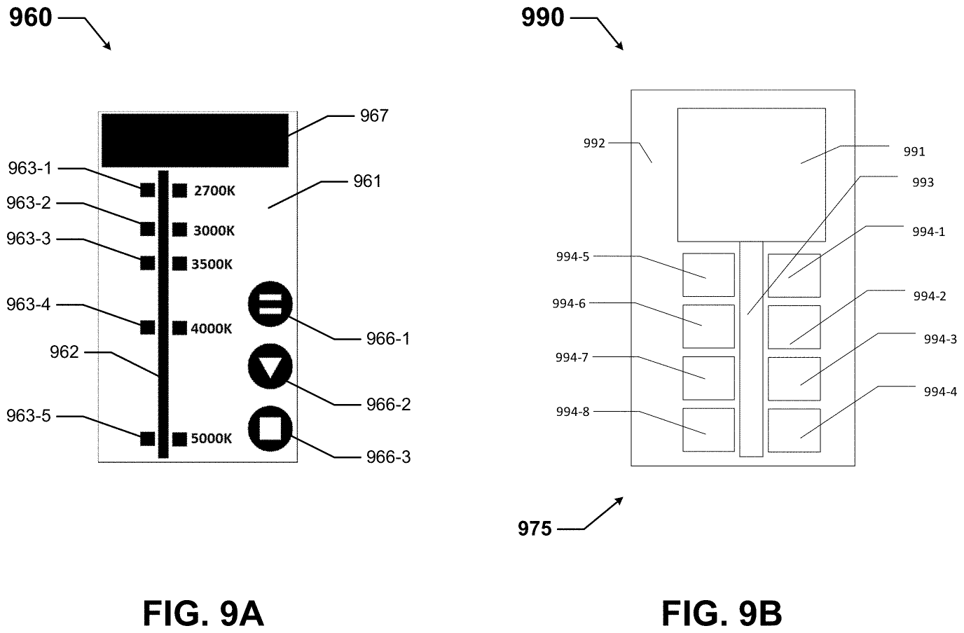

In some cases, the passive array 190 of a tag 160 can alter communication signals 195 in one or more of a number of ways. For example, a passive array 190 can specifically address a communication signal 195 to one or more electrical devices 102. As another example, a communication signal 195 sent or broadcast by a passive array 190 of a tag 160 can include a UUID of the passive array 190 and/or the tag 160. In this way, if there are multiple tags 160 that each send a communication signal 195, the controller 104 of the electrical device 102-1 can determine which tag 160 is sending a particular communication signal 195. More details of a passive array 190 are provided below with respect to FIGS. 9A and 9B. The passive array 190 can use one or more of a number of communication protocols (e.g., Bluetooth) in sending communication signals 195 to and/or receiving communication signals 195 from the electrical devices 102. A passive array 190 can be made of one or more electrically-conductive materials.

A user 150 (including a user system 155), the network manager 180, one or more sensor devices 165, one or more WACs 185, one or more tags 160, and/or the other electrical devices 102-N can interact with the controller 104 of the electrical device 102-1 using the application interface 126 in accordance with one or more example embodiments. Specifically, the application interface 126 of the controller 104 receives data (e.g., information, communications, instructions) from and sends data (e.g., information, communications, instructions) to the user 150 (including a user system 155), the network manager 180, the sensor devices 165, one or more WACs 185, one or more tags 160, and/or one or more of the other electrical devices 102-N. The user 150 (including a user system 155), the network manager 180, the sensor devices 165, one or more WACs 185, one or more tags 160, and/or one or more of the other electrical devices 102-N can include an interface to receive data from and send data to the controller 104 in certain example embodiments. Examples of such an interface can include, but are not limited to, a graphical user interface, a touchscreen, an application programming interface, a keyboard, a monitor, a mouse, a web service, a data protocol adapter, some other hardware and/or software, or any suitable combination thereof.

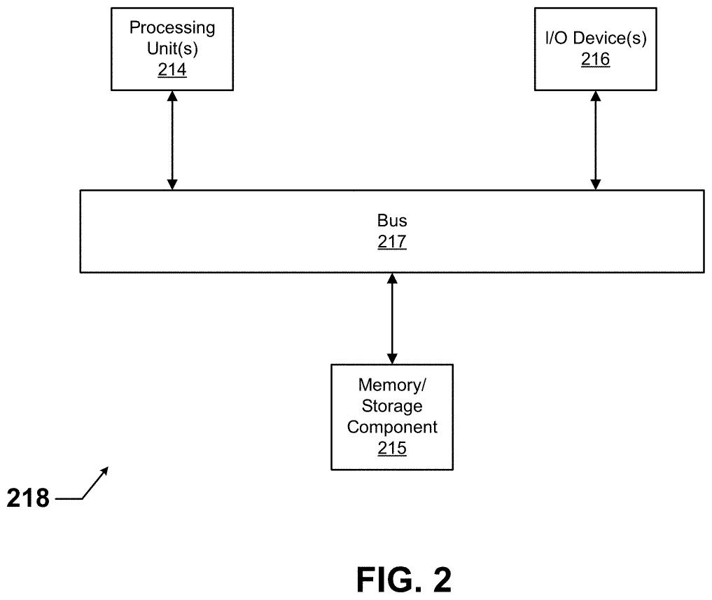

The controller 104, the user system 155 of a user 150, the network manager 180, the sensor devices 165, one or more WACs 185, one or more tags 160, and/or one or more of the other electrical devices 102-N can use their own system or share a system in certain example embodiments. Such a system can be, or contain a form of, an Internet-based or an intranet-based computer system that is capable of communicating with various software. A computer system includes any type of computing device and/or communication device, including but not limited to the controller 104. Examples of such a system can include, but are not limited to, a desktop computer with a Local Area Network (LAN), a Wide Area Network (WAN), Internet or intranet access, a laptop computer with LAN, WAN, Internet or intranet access, a smart phone, a server, a server farm, an android device (or equivalent), a tablet, smartphones, and a personal digital assistant (PDA). Such a system can correspond to a computer system as described below with regard to FIG. 2.

Further, as discussed above, such a system can have corresponding software (e.g., user software, controller software, network manager software). The software can execute on the same or a separate device (e.g., a server, mainframe, desktop personal computer (PC), laptop, PDA, television, cable box, satellite box, kiosk, telephone, mobile phone, or other computing devices) and can be coupled by the communication network (e.g., Internet, Intranet, Extranet, LAN, WAN, or other network communication methods) and/or communication channels, with wire and/or wireless segments according to some example embodiments. The software of one system can be a part of, or operate separately but in conjunction with, the software of another system within the system 100.

The electrical device 102-1 can include a housing 103. The housing 103 can include at least one wall that forms a cavity 101. In some cases, the housing 103 can be designed to comply with any applicable standards so that the electrical device 102-1 can be located in a particular environment (e.g., a hazardous environment). The housing 103 of the electrical device 102-1 can be used to house one or more components of the electrical device 102-1, including one or more components of the controller 104. For example, as shown in FIG. 1, the controller 104 (which in this case includes the control engine 106, the communication module 108, the timer 110, the power module 112, the storage repository 130, the hardware processor 120, the memory 122, the transceiver 124, the application interface 126, and the optional security module 128), the one or more sensor devices 165, an optional switch 145, one or more optional antennae 175, the power supply 140, and the electrical device components 142 are disposed in the cavity 101 formed by the housing 103. In alternative embodiments, any one or more of these or other components of the electrical device 102-1 can be disposed on the housing 103 and/or remotely from the housing 103.

The storage repository 130 can be a persistent storage device (or set of devices) that stores software and data used to assist the controller 104 in communicating with the user 150 (including a user system 155), the network manager 180, one or more of the tags 160, the sensor devices 165, one or more WACs 185, and one or more of the other electrical devices 102-N within the system 100. In one or more example embodiments, the storage repository 130 stores one or more protocols 132, one or more algorithms, 133, and tag data 134.

The protocols 132 can be any procedures (e.g., a series of method steps) and/or other similar operational procedures that the control engine 106 of the controller 104 follows based on certain conditions at a point in time. The protocols 132 can also include any of a number of communication protocols that are used to send and/or receive data between the controller 104 and the user 150 (including a user system 155), the network manager 180, the one or more of the other electrical devices 102-N, the sensor devices 165, one or more WACs 185, and one or more of the tags 160. One or more of the protocols 132 used for communication can be a time-synchronized protocol. Examples of such time-synchronized protocols can include, but are not limited to, a highway addressable remote transducer (HART) protocol, a wirelessHART protocol, and an International Society of Automation (ISA) 100 protocol. In this way, one or more of the protocols 132 used for communication can provide a layer of security to the data transferred within the system 100.

The algorithms 133 can be any formulas, mathematical models, forecasts, simulations, and/or other similar tools that the control engine 106 of the controller 104 uses to reach a computational conclusion. An example of one or more algorithms 133 is calculating or otherwise determining the frequency of a communication signal 195. Algorithms 133 can be used to analyze past data, analyze current data, and/or perform forecasts.

One or more particular algorithms 133 can be used in conjunction with one or more particular protocols 132. For example, one or more protocols 132 and one or more algorithms 133 can be used in conjunction with each other to determine the contents of a communication signal 195, including an ID of the tag 160 sending the communication signal 195 and/or an ID of the intended recipient of the communication signal 195.

Tag data 134 can be any data associated with each tag 160 (including an associated passive array 190) that is or is capable of being communicably coupled to the controller 104. Such tag data 134 can include, but is not limited to, a manufacturer of a tag 160, a model number of the tag 160, communication capability of the passive array 190 of a tag 160, last known location of a tag 160, and age of a tag 160.

Examples of a storage repository 130 can include, but are not limited to, a database (or a number of databases), a file system, a hard drive, flash memory, some other form of solid state data storage, or any suitable combination thereof. The storage repository 130 can be located on multiple physical machines, each storing all or a portion of the protocols 132, the algorithms 133, and/or the tag data 134 according to some example embodiments. Each storage unit or device can be physically located in the same or in a different geographic location.

The storage repository 130 can be operatively connected to the control engine 106. In one or more example embodiments, the control engine 106 includes functionality to communicate with a user 150 (including a user system 155), the network manager 180, the tags 160, the sensor devices 165, one or more WACs 185, and the other electrical devices 102-N in the system 100. More specifically, the control engine 106 sends information to and/or receives information from the storage repository 130 in order to communicate with the user 150 (including a user system 155), the network manager 180, the tags 160, the sensor devices 165, one or more WACs 185, and the other electrical devices 102-N. As discussed below, the storage repository 130 can also be operatively connected to the communication module 108 in certain example embodiments.

In certain example embodiments, the control engine 106 of the controller 104 controls the operation of one or more components (e.g., the communication module 108, the timer 110, the transceiver 124) of the controller 104. For example, the control engine 106 can put the communication module 108 in “sleep” mode when there are no communications between the controller 104 and another component (e.g., a tag 160, a sensor device 165, a WAC 185, the user system 155 of a 150) in the system 100 or when communications between the controller 104 and another component in the system 100 follow a regular pattern. In such a case, power consumed by the controller 104 is conserved by only enabling the communication module 108 when the communication module 108 is needed.

As another example, the control engine 106 can direct the timer 110 when to provide a current time, to begin tracking a time period, and/or perform another function within the capability of the timer 110. As yet another example, the control engine 106 can direct the transceiver 124 to send communication signals 195 (or other types of communication) and/or stop sending communication signals 195 (or other types of communication) to one or more tags 160, one or more sensor devices 165, the network manager, and/or one or more optional WACs 185 in the system 100. The control engine 106 can also instruct a sensor device 165 to communicate with a tag 160 (or a passive array 190 thereof), with a WAC 185, and/or with the controller 104.

The control engine 106 can determine when to broadcast one or more communication signals 195 to one or more tags 160. To conserve energy, the control engine 106 may not constantly broadcast communication signals 195, but rather may only do so at discrete times. The control engine 106 can broadcast a communication signal 195 based on one or more of a number of factors, including but not limited to passage of time, the occurrence of an event, instructions from a user 150 (including a user system 155), and a command received from the network manager 180. The control engine 106 can coordinate with the controllers 104 of one or more of the other electrical devices 102-N and/or directly control one or more of the other electrical devices 102-N to broadcast multiple communication signals 195. The control engine 106 can also determine the signal strength (e.g., RSSI) of one or more of the communication signals 195 that are broadcast by a tag 160, in some cases in response to a communication signal 195 broadcast by the electrical device 102-1.

In some cases, the control engine 106 of the electrical device 102-1 (and/or the control engine of another electrical device 102), using one or more protocols 132 and/or one or more algorithms 133, can determine the frequency of a communication signal 195 received from a passive array 190 of a tag 160. In certain example embodiments, the control engine 106 of the electrical device 102-1 (and/or the control engine of another electrical device 102), using one or more protocols 132 and/or one or more algorithms 133, can determine the contents of a communication signal 195, including an ID of the tag 160 sending the communication signal 195 and/or an ID of the intended recipient of the communication signal 195.

The control engine 106 of the controller 104 can also use the protocols 132 and/or the algorithms 133 to generate a subsequent communication signal 195 to an optional WAC 185, to another electrical device 102, and/or to the network manager 180 that is based on receipt of the communication signal 195 from a passive array 190 of a tag 160. For example, a subsequent communication signal 195 can include a number of bits that are directed to information such as, for example, the ID of the tag 160 and the content of the communication signal 195 received from the passive array 190 of the tag 160.

The control engine 106 can provide control, data, and/or other types of communication signals 195 to a user 150 (including an associated user device 155), the network manager 180, the other electrical devices 102-N, the sensor devices 165, one or more WACs 185, and one or more of the tags 160. Similarly, the control engine 106 can receive control, communication, and/or other similar signals from the user 150 (including an associated user device 155), the network manager 180, the other electrical devices 102-N, the sensor devices 165, one or more WACs 185, and one or more of the tags 160. The control engine 106 can communicate with each tag 160 automatically (for example, based on one or more algorithms 133 stored in the storage repository 130) and/or based on control, data, and/or other communication signals 195 received from another device (e.g., the network manager 180, another electrical device 102) using other communication signals 195. The control engine 106 may include a printed circuit board, upon which the hardware processor 120 and/or one or more discrete components of the controller 104 are positioned.

In certain example embodiments, the control engine 106 can include an interface that enables the control engine 106 to communicate with one or more components (e.g., power supply 140) of the electrical device 102-1. For example, if the power supply 140 of the electrical device 102-1 (e.g., a light fixture) operates under IEC Standard 62386, then the power supply 140 can include a digital addressable lighting interface (DALI). In such a case, the control engine 106 can also include a DALI to enable communication with the power supply 140 within the electrical device 102-1. Such an interface can operate in conjunction with, or independently of, the communication protocols 132 used to communicate between the controller 104 and the user 150 (including an associated user device 155), the network manager 180, the other electrical devices 102-N, the sensor devices 165, one or more WACs 185, and the tags 160.

The control engine 106 (or other components of the controller 104) can also include one or more hardware and/or software architecture components to perform its functions. Such components can include, but are not limited to, a universal asynchronous receiver/transmitter (UART), a serial peripheral interface (SPI), a direct-attached capacity (DAC) storage device, an analog-to-digital converter, an inter-integrated circuit (I²C), and a pulse width modulator (PWM).

By using example embodiments, while at least a portion (e.g., the control engine 106, the timer 110) of the controller 104 is always on, the remainder of the controller 104 and the tags 160 can be in sleep mode when they are not being used. In addition, the controller 104 can control certain aspects (e.g., sending communication signals 195 to and receiving communication signals 195 from a tag 160) of one or more other electrical devices 102-N in the system 100.

The communication network (using the communication links 105) of the system 100 can have any type of network architecture. For example, the communication network of the system 100 can be a mesh network. As another example, the communication network of the system 100 can be a star network. When the controller 104 includes an energy storage device (e.g., a battery as part of the power module 112), even more power can be conserved in the operation of the system 100. In addition, using time-synchronized communication protocols 132, the data transferred between the controller 104 and the user 150 (including an associated user device 155), the network manager 180, the sensor devices 165, one or more WACs 185, a tag 160, and the other electrical devices 102-N can be secure.

The communication module 108 of the controller 104 determines and implements the communication protocol (e.g., from the protocols 132 of the storage repository 130) that is used when the control engine 106 communicates with (e.g., sends communication signals 195 to, receives communication signals 195 from) the user 150 (including an associated user system 155), the network manager 180, the other electrical devices 102-N, the sensor devices 165, one or more WACs 185, and/or one or more of the tags 160. In some cases, the communication module 108 accesses the tag data 134 to determine which communication protocol is within the capability of the tag 160 for a communication signal 195 sent by the control engine 106. In addition, the communication module 108 can interpret the communication protocol of a communication signal 195 received by the controller 104 so that the control engine 106 can interpret the communication.

The communication module 108 can send data (e.g., protocols 132, algorithms 133, tag data 134, threshold values, user preferences) directly to and/or retrieve data directly from the storage repository 130. Alternatively, the control engine 106 can facilitate the transfer of data between the communication module 108 and the storage repository 130. The communication module 108 can also provide encryption to data that is sent by the controller 104 and decryption to data that is received by the controller 104. The communication module 108 can also provide one or more of a number of other services with respect to data sent from and received by the controller 104. Such services can include, but are not limited to, data packet routing information and procedures to follow in the event of data interruption.

The timer 110 of the controller 104 can track clock time, intervals of time, an amount of time, and/or any other measure of time. The timer 110 can also count the number of occurrences of an event, whether with or without respect to time. Alternatively, the control engine 106 can perform the counting function. The timer 110 is able to track multiple time measurements concurrently. The timer 110 can measure the time of flight (ToF) of one or more communication signals 195, even simultaneously. The timer 110 can track time periods based on an instruction received from the control engine 106, based on an instruction received from the user 150 (including an associated user system 155), based on an instruction programmed in the software for the controller 104, based on some other condition or from some other component, or from any combination thereof.

The power module 112 of the controller 104 provides power to one or more other components (e.g., timer 110, control engine 106) of the controller 104. In addition, in certain example embodiments, the power module 112 can provide power to the power supply 140 of the electrical device 102-1. The power module 112 can include one or more of a number of single or multiple discrete components (e.g., transistor, diode, resistor), and/or a microprocessor. The power module 112 may include a printed circuit board, upon which the microprocessor and/or one or more discrete components are positioned.

The power module 112 can include one or more components (e.g., a transformer, a diode bridge, an inverter, a converter) that receives power (for example, through an electrical cable) from the power source 140 or a source (e.g., AC mains, a battery) external to the electrical device 102-1. The power module 112 subsequently generates power of a type (e.g., alternating current, direct current) and level (e.g., 12V, 24V, 120V) that can be used by the other components of the controller 104 and/or by the power supply 140. In addition, or in the alternative, the power module 112 can be a source of power in itself to provide signals to the other components of the controller 104 and/or the power supply 140. For example, the power module 112 can include an energy storage device (e.g., a battery). As another example, the power module 112 can include a localized photovoltaic power system.

The hardware processor 120 of the controller 104 executes software in accordance with one or more example embodiments. Specifically, the hardware processor 120 can execute software on the control engine 106 or any other portion of the controller 104, as well as software used by the user system 155 of a user 150, the network manager 180, the sensor devices 165, one or more WACs 185, and/or one or more of the other electrical devices 102-N. The hardware processor 120 can be an integrated circuit, a central processing unit, a multi-core processing chip, a multi-chip module including multiple multi-core processing chips, or other hardware processor in one or more example embodiments. The hardware processor 120 is known by other names, including but not limited to a computer processor, a microprocessor, and a multi-core processor.

In one or more example embodiments, the hardware processor 120 executes software instructions stored in memory 122. The memory 122 includes one or more cache memories, main memory, and/or any other suitable type of memory. The memory 122 is discretely located within the controller 104 relative to the hardware processor 120 according to some example embodiments. In certain configurations, the memory 122 can be integrated with the hardware processor 120.

In certain example embodiments, the controller 104 does not include a hardware processor 120. In such a case, the controller 104 can include, as an example, one or more field programmable gate arrays (FPGA), one or more insulated-gate bipolar transistors (IGBTs), and/or one or more integrated circuits (ICs). Using FPGAs, IGBTs, ICs, and/or other similar devices known in the art allows the controller 104 (or portions thereof) to be programmable and function according to certain logic rules and thresholds without the use of a hardware processor. Alternatively, FPGAs, IGBTs, ICs, and/or similar devices can be used in conjunction with one or more hardware processors 120.

The transceiver 124 of the controller 104 can send (using a transmitter) and/or receive (using a receiver) control and/or communication signals, including communication signals 195. Specifically, the transceiver 124 can be used to transfer data between the controller 104 and the user 150 (including an associated user system 155), the network manager 180, the other electrical devices 102-N, one or more of the sensor devices 165, one or more WACs 185, and/or the tags 160. The transceiver 124 can use wired and/or wireless technology. The transceiver 124 can be configured in such a way that the control and/or communication signals sent and/or received by the transceiver 124 can be received and/or sent by another transceiver that is part of the user 150 (including an associated user system 155), the network manager 180, the other electrical devices 102-N, one or more sensor devices 165, one or more WACs 185, and/or the tags 160.

When the transceiver 124 uses wireless technology, any type of wireless technology can be used by the transceiver 124 in sending and receiving signals (e.g., communication signals 195). Such wireless technology can include, but is not limited to, Wi-Fi, visible light communication, infrared (IR), cellular networking, Zigbee, BLE, and Bluetooth. For example, the transceiver 124 can include a Zigbee transmitter, a Zigbee receiver, a BLE receiver, a BLE transmitter, an active IR transmitter, and/or an active IR receiver. The transceiver 124 can use one or more of any number of suitable communication protocols (e.g., ISA100, HART) when sending and/or receiving signals, including RF signals 195. Such communication protocols can be stored in the protocols 132 of the storage repository 130. Further, any transceiver information for the user 150 (including an associated user system 155), the network manager 180, the other electrical devices 102-N, the sensor devices 165, one or more WACs 185, and/or the tags 160 can be part of the tag data 134 (or other areas) of the storage repository 130.

Optionally, in one or more example embodiments, the security module 128 secures interactions between the controller 104, the user 150, the network manager 180, the other electrical devices 102-N, the sensor devices 165, one or more WACs 185, and/or the tags 160. More specifically, the security module 128 authenticates communication from software based on security keys verifying the identity of the source of the communication. For example, user software may be associated with a security key enabling the software of the user 150 to interact with the controller 104 of the electrical device 102-1. Further, the security module 128 can restrict receipt of information, requests for information, and/or access to information in some example embodiments.

As mentioned above, aside from the controller 104 and its components, the electrical device 102-1 can include a power supply 140, one or more sensor devices 165, one or more optional antennae 175, an optional switch 145, and one or more electrical device components 142. The electrical device components 142 of the electrical device 102-1 are devices and/or components typically found in the electrical device 102-1 to allow the electrical device 102-1 to operate. An electrical device component 142 can be electrical, electronic, mechanical, or any combination thereof. The electrical device 102-1 can have one or more of any number and/or type of electrical device components 142. For example, when the electrical device 102-1 is a light fixture, examples of such electrical device components 142 can include, but are not limited to, a light source, a light engine, a heat sink, an electrical conductor or electrical cable, a terminal block, a lens, a diffuser, a reflector, an air moving device, a baffle, a dimmer, and a circuit board.

The power supply 140 of the electrical device 102-1 provides power to one or more of the electrical device components 142. The power supply 140 can be substantially the same as, or different than, the power module 112 of the controller 104. The power supply 140 can include one or more of a number of single or multiple discrete components (e.g., transistor, diode, resistor), and/or a microprocessor. The power supply 140 may include a printed circuit board, upon which the microprocessor and/or one or more discrete components are positioned.

The power supply 140 can include one or more components (e.g., a transformer, a diode bridge, an inverter, a converter) that receives power (for example, through an electrical cable) from or sends power to the power module 112 of the controller 104. The power supply can generate power of a type (e.g., alternating current, direct current) and level (e.g., 12V, 24V, 120V) that can be used by the recipients (e.g., the electrical device components 142, the controller 106) of such power. In addition, or in the alternative, the power supply 140 can receive power from a source external to the electrical device 102-1. In addition, or in the alternative, the power supply 140 can be or include a source of power in itself. For example, the power supply 140 can include an energy storage device (e.g., a battery), a localized photovoltaic power system, or some other source of independent power.

Each of the one or more sensor devices 165 of the electrical device 102-1 can include any type of sensing device that measures one or more parameters. Examples of types of sensor devices 165 can include, but are not limited to, a passive infrared sensor, a photocell, a pressure sensor, an air flow monitor, a gas detector, and a resistance temperature detector. Examples of a parameter that is measured by a sensor device 165 can include, but are not limited to, occupancy in the volume of space 199, motion in the volume of space 199, a temperature, a level of gas, a level of humidity, an amount of ambient light in the volume of space 199, and a pressure wave.

In some cases, the parameter or parameters measured by a sensor device 165 can be used to operate one or more of the electrical device components 142 of the electrical device 102-1. In addition, or in the alternative, the one or more parameters measured by a sensor device 165 can be used to locate one or more tags 160 in accordance with certain example embodiments. For example, if a sensor device 165 is configured to detect the presence of an tag 160, that information can be used to determine whether a communication (e.g., a RF signal 195) received from a passive array 190 of an tag 160 should be forwarded to a network manager 180.

A sensor device 165 can be an integrated sensor. In integrated sensor has both the ability to sense and measure at least one parameter and the ability to communicate with another component (e.g., the passive array 190 of an tag 160, a WAC 185). The communication capability of a sensor device 165 that is an integrated sensor can include one or more communication devices that are configured to communicate with, for example, the controller 104 of the electrical device 102-1, a WAC 185, and/or a controller (substantially similar to the controller 104 described herein) of another electrical device 102-N. For example, an integrated sensor device 165 can include a passive infrared (PIR) sensor, a transceiver that sends and receives signals using Zigbee, a receiver that receives signals using BLE, and a receiver that actively receives IR signals. In such a case, the PIR sensor measures IR light radiating from objects in its field of view, often for the purpose of detecting motion.

Each sensor device 165 can use one or more of a number of communication protocols. This allows a sensor device 165 to communicate with one or more components (e.g., a passive array 190 of a tag 160, a WAC 185, one or more other integrated sensor devices 165) of the system 100. The communication capability of a sensor device 165 that is an integrated sensor can be dedicated to the sensor device 165 and/or shared with the controller 104 of the electrical device 102-1. When the system 100 includes multiple integrated sensor devices 165, one integrated sensor device 165 can communicate, directly or indirectly, with one or more of the other integrated sensor devices 165 in the system 100.

If the communication capability of a sensor device 165 is an integrated sensor is dedicated to the sensor device 165, then the sensor device 165 can include one or more components (e.g., a transceiver 124, a communication module 108), or portions thereof, that are substantially similar to the corresponding components described above with respect to the controller 104. A sensor device 165 can be associated with the electrical device 102-1 and/or another electrical device 102 in the system 100. A sensor device 165 can be located within the housing 103 of the electrical device 102-1, disposed on the housing 103 of the electrical device 102-1, or located outside the housing 103 of the electrical device 102-1. In some cases, a sensor device 165 can be considered its own electrical device 102.

In certain example embodiments, a sensor device 165 can include an energy storage device (e.g., a battery) that is used to provide power, at least in part, to some or all of the sensor device 165. In such a case, the energy storage device can be the same as, or independent of, an energy storage device or other power supply 140 of the electrical device 102-1. The optional energy storage device of the sensor module 165 can operate at all times or when the power supply of the electrical device 102-1 is interrupted. Further, a sensor device 165 can utilize or include one or more components (e.g., memory 122, storage repository 130, transceiver 124) found in the controller 104. In such a case, the controller 104 can provide the functionality of these components used by the sensor device 165. Alternatively, the sensor device 165 can include, either on its own or in shared responsibility with the controller 104, one or more of the components of the controller 104. In such a case, the sensor device 165 can correspond to a computer system as described below with regard to FIG. 2.

As discussed above, the electrical device 102 can include one or more optional antennae 175. An antenna 175 is an electrical device that converts electrical power to communication signals 195 (for transmitting) and communication signals 195 to electrical power (for receiving). In transmission, a radio transmitter (e.g., transceiver 124) supplies, through the optional switch 145 when multiple antenna 175 are involved, an electric current oscillating at radio frequency (i.e. a high frequency alternating current (AC)) to the terminals of the antenna 175, and the antenna 175 radiates the energy from the current as communication signals 195 (e.g., RF signals). In reception, an antenna 175, when included in the electrical device 102-1, intercepts some of the power of communication signals 195 in order to produce a tiny voltage at its terminals, that is applied to a receiver (e.g., transceiver 124), in some cases through an optional switch 145, to be amplified.

An antenna 175 can typically consist of an arrangement of electrical conductors that are electrically connected to each other (often through a transmission line) to create a body of the antenna 175. The body of the antenna 175 is electrically coupled to the transceiver 124. An oscillating current of electrons forced through the body of an antenna 175 by the transceiver 124 will create an oscillating magnetic field around the body, while the charge of the electrons also creates an oscillating electric field along the body of the antenna 175. These time-varying fields radiate away from the antenna 175 into space as a moving transverse communication signal 195 (often an electromagnetic field wave). Conversely, during reception, the oscillating electric and magnetic fields of an incoming communication signal 195 exert force on the electrons in the body of the antenna 175, causing portions of the body of the antenna 175 to move back and forth, creating oscillating currents in the antenna 175.

In certain example embodiments, an antenna 175 can be disposed at, within, or on any portion of the electrical device 102-1. For example, an antenna 175 can be disposed on the housing 103 of the electrical device 102-1 and extend away from the electrical device 102-1. As another example, an antenna 175 can be insert molded into a lens of the electrical device 102-1. As another example, an antenna 175 can be two-shot injection molded into the housing 103 of the electrical device 102-1. As yet another example, an antenna 175 can be adhesive mounted onto the housing 103 of the electrical device 102-1. As still another example, an antenna 175 can be pad printed onto a circuit board within the cavity 101 formed by the housing 103 of the electrical device 102-1. As yet another example, an antenna 175 can be a chip ceramic antenna that is surface mounted. As still another example, an antenna 175 can be a wire antenna.

When there are multiple antennae 175 (or other forms of multiple communication points) as part of the electrical device 102-1, there can also be an optional switch 145, which allows for selection of one communication point at a given point in time. In such a case, each antenna 175 can be electrically coupled to the switch 145, which in turn is electrically coupled to the transceiver 124. The optional switch 145 can be a single switch device or a number of switch devices arranged in series and/or in parallel with each other. The switch 145 determines which antenna 175 is coupled to the transceiver 124 at any particular point in time. A switch 145 can have one or more contacts, where each contact has an open state (position) and a closed state (position).

In the open state, a contact of the switch 145 creates an open circuit, which prevents the transceiver 124 from delivering a communication signal 195 to or receiving a communication signal 195 from the antenna 175 electrically coupled to that contact of the switch 145. In the closed state, a contact of the switch 145 creates a closed circuit, which allows the transceiver 124 to deliver a RF signal 195 to or receive a communication signal 195 from the antenna 175 electrically coupled to that contact of the switch 145. In certain example embodiments, the position of each contact of the switch 145 is controlled by the control engine 106 of the controller 104.

If the switch 145 is a single device, the switch 145 can have multiple contacts. In any case, only one contact of the switch 145 can be active (closed) at any point in time in certain example embodiments. Consequently, when one contact of the switch 145 is closed, all other contacts of the switch 145 are open in such example embodiments.

FIG. 2 illustrates one embodiment of a computing device 218 that implements one or more of the various techniques described herein, and which is representative, in whole or in part, of the elements described herein pursuant to certain exemplary embodiments. For example, computing device 218 can be implemented in the electrical device 102-1 of FIG. 1 in the form of the hardware processor 120, the memory 122, and the storage repository 130, among other components. Computing device 218 is one example of a computing device and is not intended to suggest any limitation as to scope of use or functionality of the computing device and/or its possible architectures. Neither should computing device 218 be interpreted as having any dependency or requirement relating to any one or combination of components illustrated in the example computing device 218.

Computing device 218 includes one or more processors or processing units 214, one or more memory/storage components 215, one or more input/output (I/O) devices 216, and a bus 217 that allows the various components and devices to communicate with one another. Bus 217 represents one or more of any of several types of bus structures, including a memory bus or memory controller, a peripheral bus, an accelerated graphics port, and a processor or local bus using any of a variety of bus architectures. Bus 217 includes wired and/or wireless buses.

Memory/storage component 215 represents one or more computer storage media. Memory/storage component 215 includes volatile media (such as random access memory (RAM)) and/or nonvolatile media (such as read only memory (ROM), flash memory, optical disks, magnetic disks, and so forth). Memory/storage component 215 includes fixed media (e.g., RAM, ROM, a fixed hard drive, etc.) as well as removable media (e.g., a Flash memory drive, a removable hard drive, an optical disk, and so forth).

One or more I/O devices 216 allow a customer, utility, or other user to enter commands and information to computing device 218, and also allow information to be presented to the customer, utility, or other user and/or other components or devices. Examples of input devices include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 218 is connected to a network (not shown) (e.g., a LAN, a WAN such as the Internet, or any other similar type of network) via a network interface connection (not shown) according to some exemplary embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other exemplary embodiments. Generally speaking, the computer system 218 includes at least the minimal processing, input, and/or output means necessary to practice one or more embodiments.

Further, those skilled in the art will appreciate that one or more elements of the aforementioned computer device 218 is located at a remote location and connected to the other elements over a network in certain exemplary embodiments. Further, one or more embodiments is implemented on a distributed system having one or more nodes, where each portion of the implementation (e.g., control engine 106) is located on a different node within the distributed system. In one or more embodiments, the node corresponds to a computer system. Alternatively, the node corresponds to a processor with associated physical memory in some exemplary embodiments. The node alternatively corresponds to a processor with shared memory and/or resources in some exemplary embodiments.

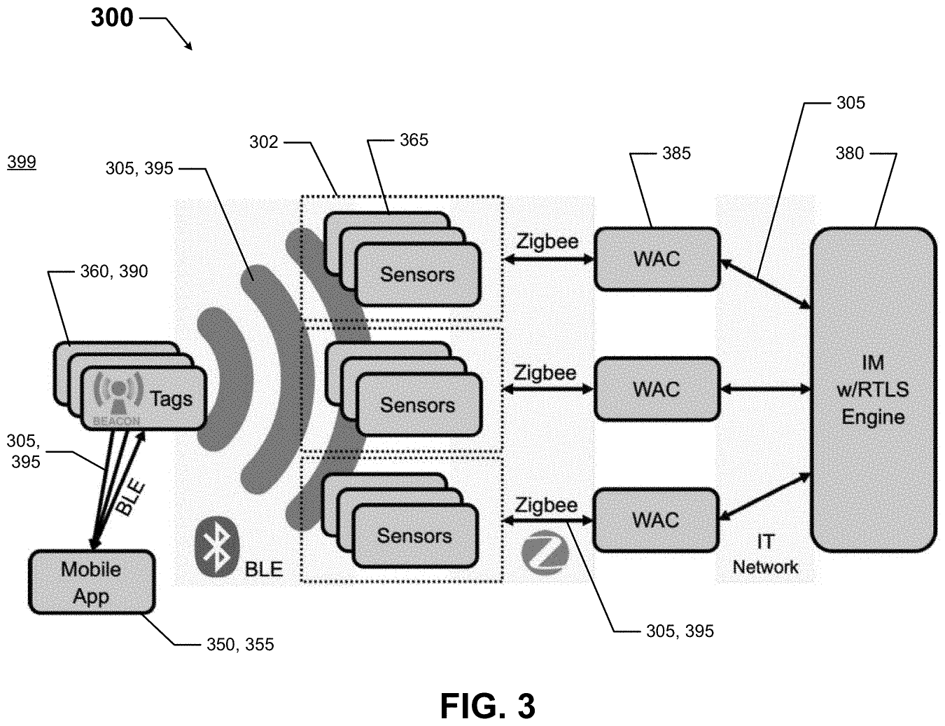

FIG. 3 shows a diagram of another system 300 in accordance with certain example embodiments. Referring to FIGS. 1 through 3, the system 300 includes a user 350 with a user system 355, multiple tags 360 each having a passive array 390, a number of electrical devices 302 each of which can include one or more sensor devices 365, a number of WACs 385, and a network manager 380, at least some of which are located in a volume of space 399. Each of these components of the system 300 of FIG. 3 can be substantially the same as the corresponding component of the system 100 of FIG. 1.

In this particular case, the passive arrays 390 of the tags 360 transmit communication signals 395 in the form of RF signals using communication links 305 that are BLE-enabled. The electrical devices 302 that are within range of the communication signals 395 transmitted by the passive array 390 of the tag 360 receive those communication signals 395.

The communication signals 395 are sent and received in real time. As used herein, “real time” refers to a user's perspective of the system 300 and means that information in communication signals 395 can be processed (e.g., ranging from a few milliseconds to a few seconds), which time is virtually real time from the user's perspective. In this example, the electrical devices 302 can communicate with one or more WACs 385 using Zigbee-enabled communication links 305. In this case, each electrical device 302 is a Zigbee-enabled device as well as a BLE-enabled device, and so each electrical device 302 can be paired with a single WAC 385.

The WACs 385, upon receiving the communication signals 395 from the electrical devices 302 on the Zigbee-enabled communication links 305, send the information in these communication signals 395 to the network manager 380, which process all of this information (e.g., using one or more algorithms 133) for one or more purposes. For example, the network manager 380 can store this information and use it for trending analysis, predictive analysis, and/or any other analysis that may be useful.

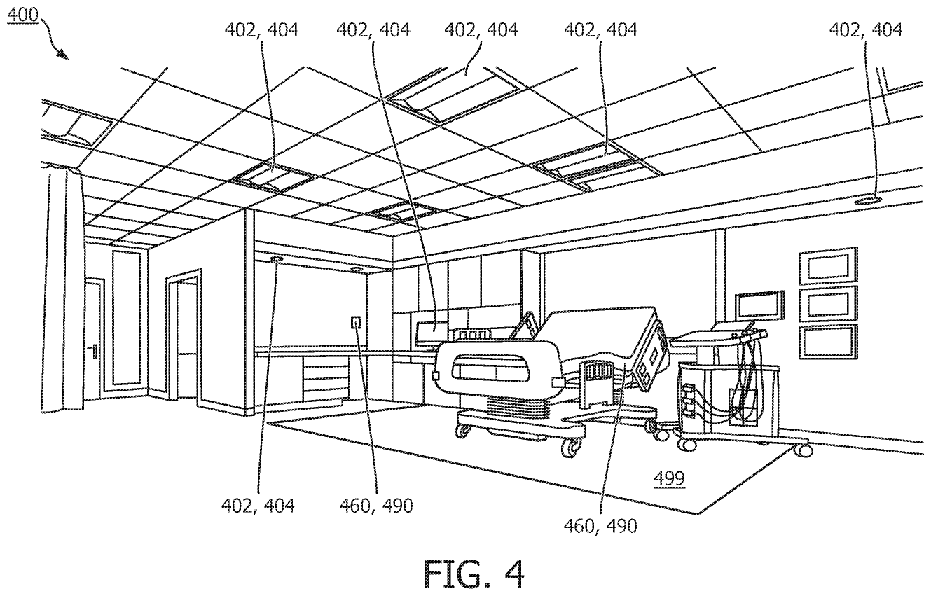

FIG. 4 shows a lighting system 400 that can be used with a tag 460 in accordance with certain example embodiments. Referring to FIGS. 1 through 4, the lighting system 400 includes a number of electrical devices 402, principally in the form of light fixtures, located in a volume of space 499 that includes a hospital room. The electrical devices 402 of the lighting system 400 of FIG. 4 form a dense network. Of the electrical devices 402 that are light fixtures, there are seven troffer light fixtures and five down can light fixtures disposed in the ceiling. There is also an electrical device 402 in the form of a computer monitor. In this case, each electrical device 402 includes a controller 404, substantially similar to the controller 404 discussed above. There are also two example tags 460 shown in FIG. 4. One tag 460 is disposed on a bed frame, and the other tag 460 is a mounted on a wall in the volume of space 499. Each tag 460 in this case includes a passive array 490 that is capable of communicating with the controller 404 of one or more electrical devices 402.

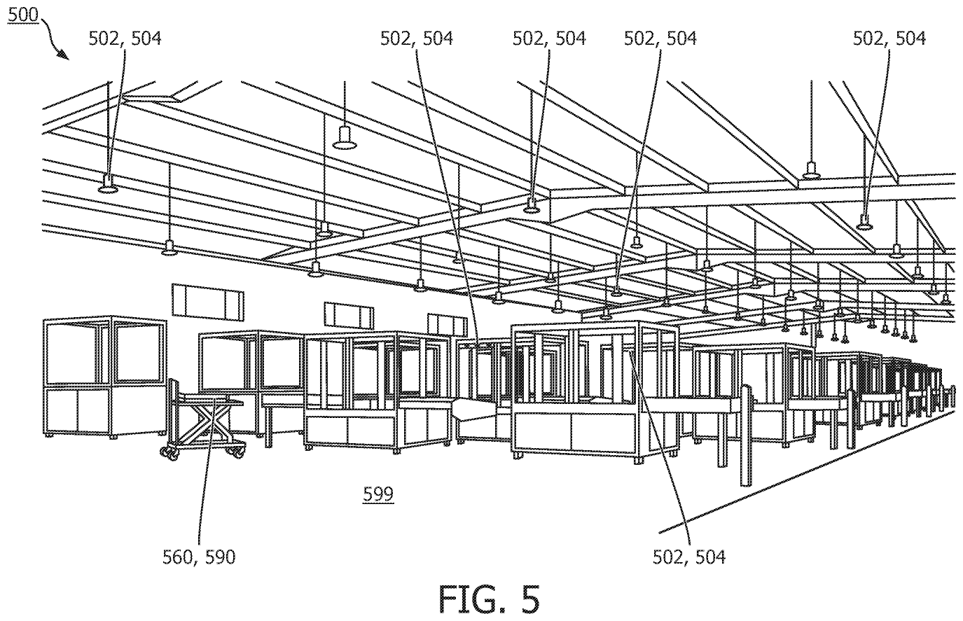

FIG. 5 shows a lighting system 500 that can be used with a tag 560 in accordance with certain example embodiments. Referring to FIGS. 1 through 5, the lighting system 500 includes a number of electrical devices 502, principally in the form of light fixtures, located in a volume of space 599 that includes a manufacturing facility. Of the electrical devices 502 that are light fixtures, there are at least 56 Hi-Bay light fixtures suspended from the ceiling and at least 30 work stations located on the floor. In this case, each electrical device 502 includes a controller 404, substantially similar to the controller 404 discussed above. There is also a tag 560 shown in FIG. 5 that is disposed on the wall of a cart. The tag 560 in this case includes a passive array 590 that is capable of communicating with the controller 504 of one or more electrical devices 502.

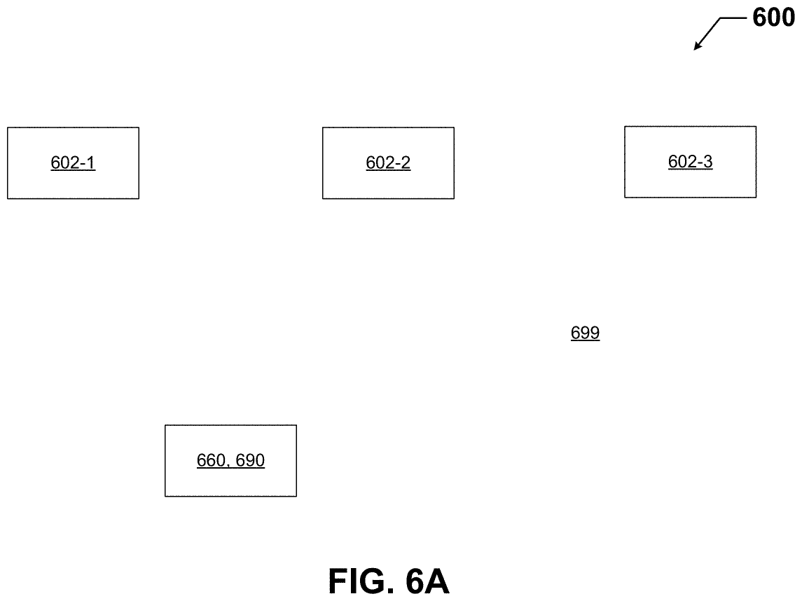

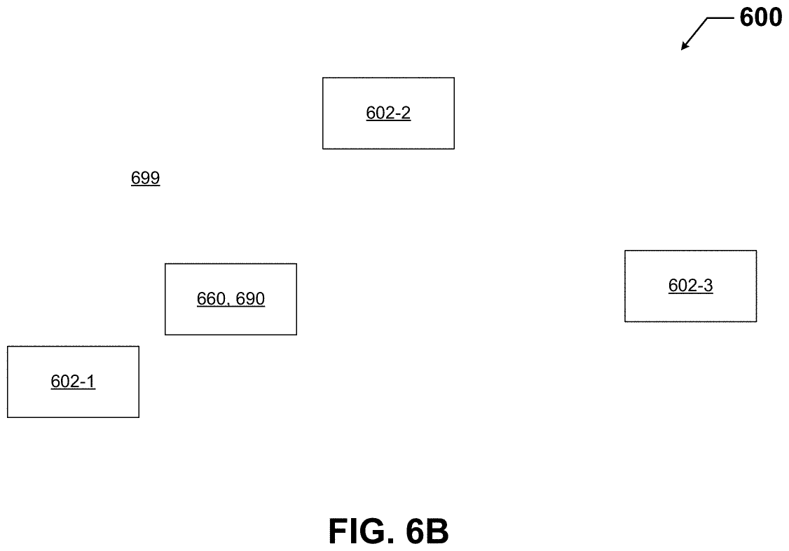

FIGS. 6A and 6B show a side and top view, respectively, of a system 600 in which an example tag 660 (including its corresponding passive array 690) is located in volume of space 699 in accordance with certain example embodiments. Referring to FIGS. 1 through 6B, also located in the volume of space 699 of FIGS. 6A and 6B are three light fixtures 602 (specifically, light fixture 602-1, light fixture 602-2, and light fixture 602-3), where the light fixtures 602 are types of electrical devices 102 of FIG. 1 above. As discussed above, the volume of space 699 can be of any size and/or in any location. For example, the volume of space 699 can be one or more rooms in an office building.

As shown in FIGS. 6A and 6B, all of the light fixtures 602 can be located in the volume of space 699. Alternatively, one or more of the light fixtures 602 can be located outside the volume of space 699, as long as the communication signals (e.g., communication signals 195) sent by the transceiver (e.g., transceiver 124) of the light fixture 602 are received by the passive array 690 of the tag 660, and as long as the communication signals sent by the passive array 690 of the tag 660 are received by the transceiver of the corresponding light fixture 602, as applicable.

Each of the light fixtures 602 can include a controller and an associated transceiver, substantially similar to the controller 104 and associated transceiver 124 discussed above. In this example, the transceiver of light fixture 602-1, light fixture 602-2, and light fixture 602-3 includes a Zigbee-enabled transceiver and a BLE-enabled transceiver. In such a case, the BLE-enabled receiver of each light fixture 602 is capable of transmitting communication signals (e.g., communication signals 195) in the form of RF signals with the passive array 690 of the tag 660.

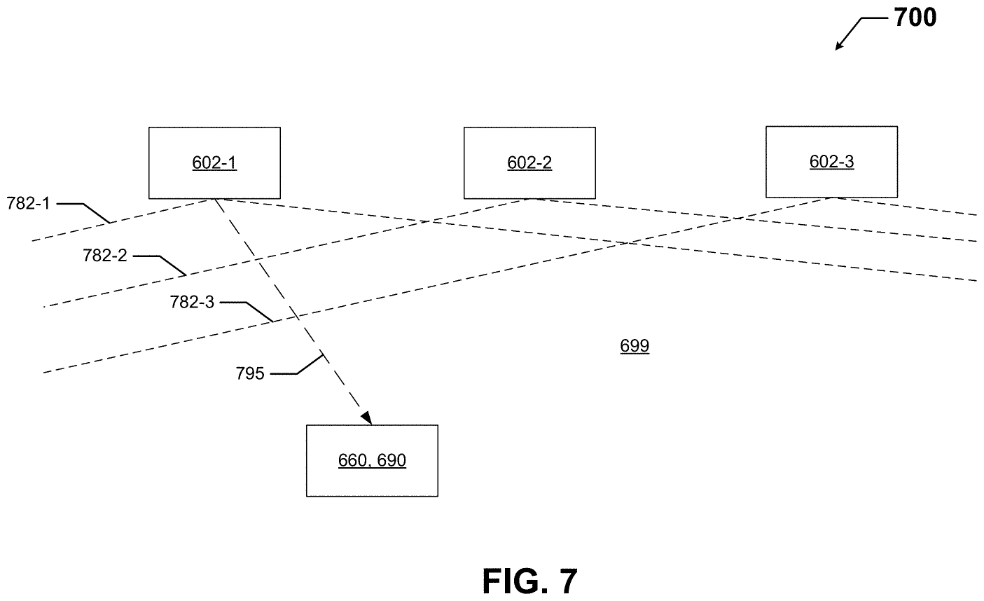

FIG. 7 shows the system 700 of FIGS. 6A and 6B when a communication signal 795 is sent by light fixture 602-1 in accordance with certain example embodiments. Referring to FIGS. 1 through 7, the transceiver of each light fixture 602 has a broadcast range 782. In this case, the transceiver of light fixture 602-1 has broadcast range 782-1, the transceiver of light fixture 602-2 has broadcast range 782-2, and the transceiver of light fixture 602-3 has broadcast range 782-3. Since the passive array 690 of the tag 660 is located within the broadcast range 782-1 for the transceiver of light fixture 602-1, the passive array 690 of the tag 660 receives communication signal 795.

Specifically, the transceiver of light fixture 602-1 can send (e.g., broadcast) a communication signal 795 into the volume of space 699, and the passive array 690 of the tag 660 receives the communication signal 795 because the passive array 690 of the tag 660 is within the broadcast range 782-1. The communication signal 795 can be sent, as an example, using BLE. In alternative embodiments, the transceiver of each light fixture 602 can be enabled for some other communication protocol aside from BLE. Examples of such other communication protocols can include, but are not limited to, Bluetooth, Zigbee, and Wi-Fi. In any case, the passive array 690 of the example tag 660 can receive the communication signal 795 sent by the transceiver of light fixture 602-1.

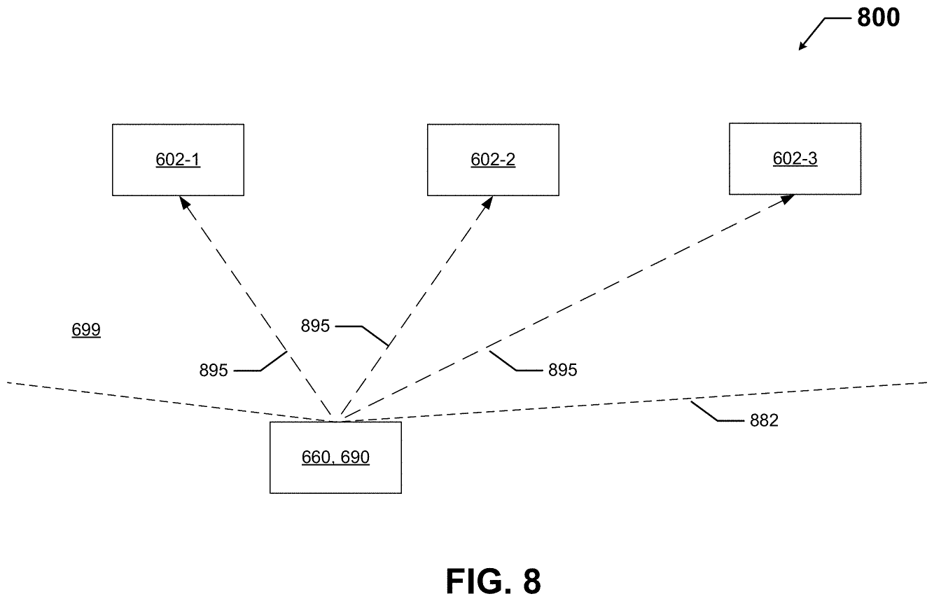

FIG. 8 shows the system 800 of FIGS. 6A through 7 when a return communication signal 895 is sent by the passive array 690 of the tag 660 in accordance with certain example embodiments. Referring to FIGS. 1 through 8, the return communication signal 895 sent by the passive array 690 of the tag 660 can be in response to the communication signal 795 sent by light fixture 602-1, as shown in FIG. 7. Specifically, the passive array 690 of the tag 660 uses the energy of the communication signal 795 sent by the transceiver of light fixture 602-1 to generate and send the return communication signal 895. As a result, the communication signal 895 uses the same communication protocol as what was used for communication signal 795. As discussed above, the communication signal 895 broadcast by the passive array 690 of the tag 660 can include the UUID of the tag 660 (or portion thereof) as well as other code, such as, for example, identifying information of the light fixture 602-1 that sent the communication signal 795.

The passive array 690 of the tag 660 has a broadcast range 882, and all three of the light fixtures 602 are located within the broadcast range 882 of the passive array 690 of the tag 660. As a result, as shown in FIG. 8, all three of the light fixtures 602 receive the communication signal 895 broadcast by the passive array 690 of the tag 660. When each light fixture 602 receives the communication signal 895 broadcast by the passive array 690 of the tag 660, the controller of that light fixture 602 can process the communication signal 895 to determine its contents.

FIGS. 9A and 9B show a passive tag 960 in accordance with certain example embodiments. Specifically, FIG. 9A shows a front view of the example tag 960, and FIG. 9B shows a front view of some of the passive array 990 of the passive tag 960. Essentially, the passive array 990 (or portions thereof) of FIG. 9B become visible when the body 961 of the tag 960 is removed.

Referring to FIGS. 1 through 9B, the passive tag 960 shown in FIG. 9A includes a body 961 on which a number of labels are disposed. These labels are designed to provide guidance to a user (e.g., user 150) as to where on the body 961 a user can touch to initiate a communication signal (e.g., communication signal 195) that changes a setting and/or mode of operation of an electrical device (e.g., electrical device 902). In this case, disposed on the body 961 at the top end is a mask 967 that covers an antenna base 991 of an antenna assembly 975 of the passive array 990, as shown in FIG. 9B.

Also disposed on the body 961 of the tag 960 are a number (in this case, five) of settings 963 (also called touch points 963 or TPs 963) centered around a linear feature 962. The linear feature 962 is a type of mask that covers an antenna trunk 993 of the antenna assembly 975 of the passive array 990. The TPs 963 in this case are for different correlated color temperatures (CCTs) for light emitted by a light source of an electrical device (e.g., electrical device 102). TP 963-1 is for a CCT of 2700K, TP 963-2 is for a CCT of 3000K, TP 963-3 is for a CCT of 3500K, TP 963-4 is for a CCT of 4000K, and TP 963-5 is for a CCT of 5000K.

Corresponding to each of these TPs 963 on the body 961 of the tag 960 are one or more resonators 994 of the antenna assembly 975 of the passive array 990. In this case, resonator 994-1 and resonator 994-5 are positioned behind TP 963-2, resonator 994-2 and resonator 963-6 are positioned behind TP 963-3, resonator 994-3 and resonator 963-7 are positioned behind TP 963-4, and resonator 994-4 and resonator 9363-8 are positioned behind TP 963-5 on the body 961 of the tag 960. As discussed above, the antenna assembly 975 of the passive array 990 can be made up of multiple portions. In this case, the antenna assembly 975 is made up of the antenna base 991, the antenna trunk 993 that stems from the antenna base 991, and multiple resonators 994 that stem from the antenna trunk 993. The antenna assembly 975 of the passive array 990 can be substantially similar to the antenna 175 discussed above with respect to FIG. 1.

To simplify FIG. 9B, the resonators 994 associated with setting 963-1 (TP 963-1) are not shown. Similarly, the resonators associated with the three functional buttons 966 are also not shown as part of the passive array 990 of FIG. 9B. (In some cases, the functional buttons 966 can be considered types of TPs 963.) The various portions of the antenna assembly 975 (e.g., the resonators 994, the antenna trunk 993, the antenna base 991) in this case are disposed on a substrate 992, which can be electrically non-conductive (e.g., paper, plastic). As shown in FIG. 9A, the functional buttons 966 are located toward the lower left corner of the body 961 of the tag 960. Functional button 966-1 is to pause a process, functional button 966-2 is to play or continue a process, and functional button 966-2 is to stop a process.

What is not included in the tag 960 and associated passive array 990 of FIGS. 9A and 9B is part of what makes the example tags discussed herein unique. For example, the tag 960 and associated passive array 990 of FIGS. 9A and 9B does not have any power source (e.g., a battery, a feed from AC mains). As another example, there are no ICs or other components that are used for certain communication protocols, such as Bluetooth, BLE, or Zigbee. Instead, the example tag 960 uses the touch of a human user 150 at a particular location on the passive array 990 (through the body 961 of the tag 960) to alter a communication signal received from an electrical device and send the altered communication signal back to the electrical device and/or another electrical device. Tags that are currently used in the art have a power source and components (e.g., ICs) dedicated to one or more communication protocols.

When a portion of the antenna assembly 975 of the passive array 990 is contacted, through the body 961 of the tag 960, by an object (e.g., a finger of a user 150, a stylus), the inductance of the antenna assembly 975 changes. In addition, the static charge from certain objects (e.g., a finger of a user 150) can change one or more areas of performance of the antenna assembly 975. Examples of such areas of performance can include, but are not limited to, a shift in resonance frequency, a variation in return loss, and a change in the value of the specific absorption rate (SAR). Variations in these performance areas of the antenna assembly 975 to encode communication signals (e.g., communication signals 195) for controlling one or more electrical devices (e.g., electrical devices 102) without an energy source, without a transistor (as is used with RFID passive tags), and without hardware dedicated to communication protocols.

As a specific example, if the passive array 990 of the tag 960 receives a communication signal from an electrical device (e.g., electrical device 102-1) that includes a light fixture while a user is touching TP 963-2 with a finger, the passive array 990 returns a modified communication signal to the electrical device instructing the light fixture to make adjustments so that the CCT output by the light fixture is 3500K.

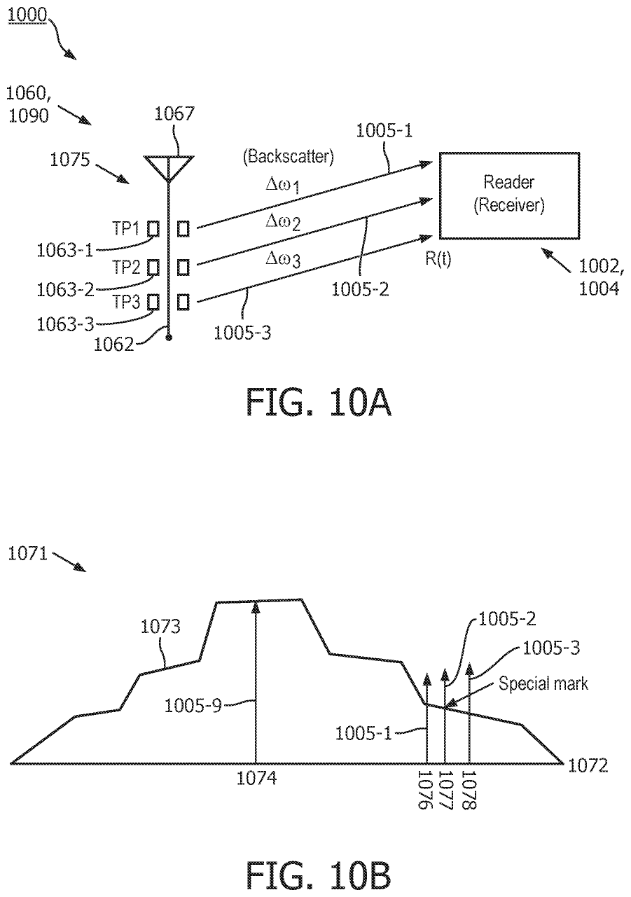

FIGS. 10A and 10B show how the passive tag system described herein can work. Specifically, FIG. 10A shows part of a system 1000 in accordance with certain example embodiments. FIG. 10B shows a graph 1071 of the communication signals 1005 transmitted by the passive tag 1060 of FIG. 10A. Referring to FIGS. 1 through 10B, the system 1000 of FIG. 10A includes a tag 1060 with a passive array 1090, where the passive array 1090 includes a mask 1067 (covering an antenna base (e.g., antenna base 991) of the passive array 1090, hidden from view), three touch points 1063 (TP 1063-1, TP 1063-2, and TP 1063-3), where each TP 1063 covers and corresponds to a resonator (e.g., resonator 994), and a linear feature 1062 (covering an antenna trunk (e.g., antenna trunk 993) of the passive array 1090, hidden from view) that connects the TPs 1063 to the mask 1067.

Each TP 1063 drives a distinct communication signal 1095 (also called backscatter) that can be received by the controller 1004 (including a receiver) of an electrical device 1002. In this case, when TP 1063-1 is contacted by the finger of a user (e.g., user 150) or some other suitable object, the antenna of the passive tag 1090 sends communication signal 1095-1 to the controller 1004 of the electrical device 1002. When TP 1063-2 is contacted by the finger of a user (e.g., user 150) or some other suitable object, the antenna of the passive tag 1090 sends communication signal 1095-2 to the controller 1004 of the electrical device 1002. When TP 1063-3 is contacted by the finger of a user (e.g., user 150) or some other suitable object, the antenna of the passive tag 1090 sends communication signal 1095-3 to the controller 1004 of the electrical device 1002. In some cases, the controller 1004 of the electrical device 1002 can make adjustments (e.g., automatically, based on input from a user) for particular configurations of example tags 1060.

Each communication signal 1095 broadcast by the passive array 1090 of the tag 1060 can have a distinct frequency shift relative to the initial communication signal. For example, as shown in FIG. 10A, communication signal 1095-1 has frequency shift Δω₁, communication signal 1095-2 has frequency shift Δω₂, and communication signal 1095-3 has frequency shift Δω₃. The Δω value of a communication signal 1095 can be introduced by the tag 1060 and taken as its identification (ID).

According to example embodiments, self-interference mitigation can be achieved without additional features or components being added to the example tag 1060 because the communication signals 1095 are placed away from the carrier (e.g., controller 1004) in such a way that they do not affect the adjacent channel power ratio (ACPR) and that they do not create out-of-band spurs. This strategic placement of the communication signals 1095 into the signal spectrum 1073 can depend on one or more of a number of factors. Such factors can include, but are not limited to, the number of resonators (e.g., resonators 994), the shape and size of the resonators, the material of the resonators, and the location of the resonators in the passive array 1090.

A number of formulas and/or algorithms can be used to calculate one or more characteristics of a communication signal 1095 broadcast by the passive array 1090 of the example tag 1060. For example, a communication signal 1095 with respect to time can be calculated as the product of the radar cross section (RCS) of the antenna assembly 1075 (or portion thereof) and the signal with Δω specific to the location of a TP 1063 (or corresponding resonator) on the tag 1060 in light of the corresponding tuning change in the antenna assembly 1075 (or portion thereof) specific to the location of the TP 1063.

An example spectrum 1073 of the communication signals 1095 is shown in FIG. 10B. Specifically, the graph 1071 of FIG. 10B shows that the spectrum 1073 of frequencies 1072 is substantially symmetrical around frequency 1074, which corresponds to ω_{c} of a communication signal 1095-9 received by the example tag 1060 and used as the basis of the backscatter communication signals 1095-1, 1095-2, and 1095-3. Communication signal 1095-1 has a frequency 1076 that is higher than frequency 1074. Communication signal 1095-2 has a frequency 1077 that is higher than frequency 1076. Communication signal 1095-3 has a frequency 1078 that is higher than frequency 1077. In some cases, the frequency shift of one or more communication signals 1095 can be outside of a band of a communication protocol (e.g., Bluetooth) and cause interference. Example embodiments can be arranged and configured to provide communication signals 1095 at frequencies that avoid such interference.

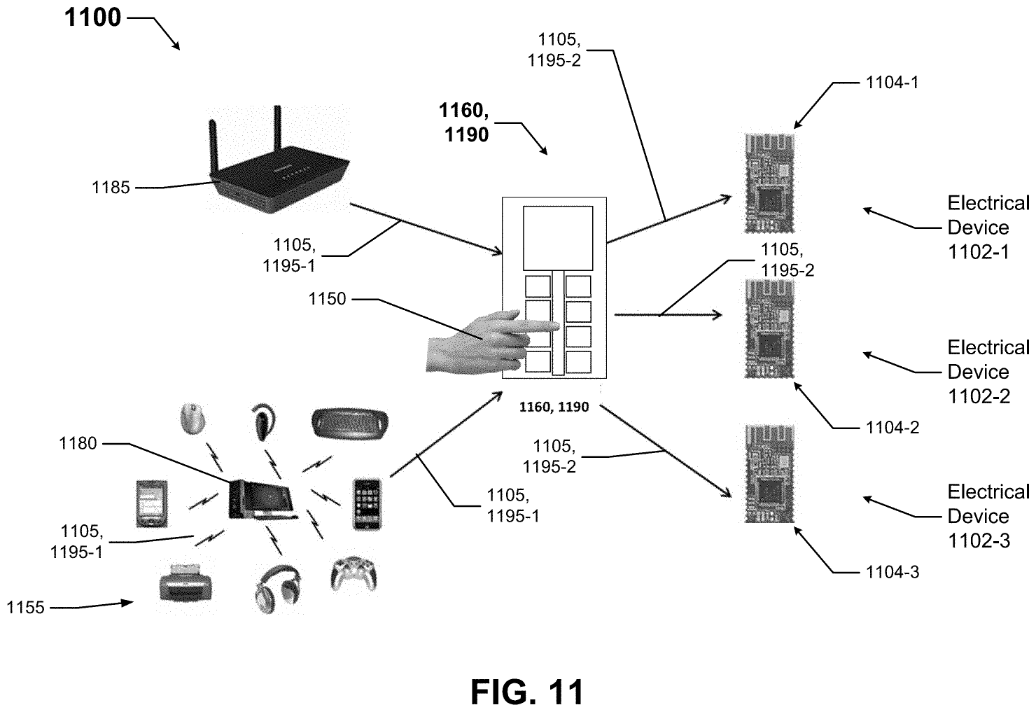

FIG. 11 shows a diagram of a system 1100 in accordance with certain example embodiments. Referring to FIGS. 1 through 11, the system 1100 of FIG. 11 includes an example tag 1160 with a passive array 1190, a number of user devices 1155, a network manager 1180, a WAC 1185, and three electrical devices 1102 (electrical device 1102-1, electrical device 1102-2, and electrical device 1102-3). All of these components of the system 1100 are communicably coupled with each other using communication links 1105. There is also a user 1150 that is interacting with the passive array 1190 of the tag 1160. The passive array 1190 is visible in FIG. 11 because the body (e.g., body 961) of the tag 960 is removed.

The various components (e.g., the tag 1160, the passive array 1190, the user devices 1155, the network manager 1180, the WAC 1185, the electrical devices 1102, the user 1150) can be substantially the same as the corresponding components discussed above with respect to FIGS. 1 through 9. The system 1100 of FIG. 11 is arranged in a bistatic architecture. In this case, the passive array 1190 of the tag 1160 receives one or more communication signals 1195-1, using the communication links 1105, from one or more user devices 1155, the network manager 1180, and/or the WAC 1185. The communication links 1105 can be used under BLE, Bluetooth, Zigbee, Wi-Fi, and/or any other communication protocol in transmitting the communication signals 1195-1.

The user 1150 is interacting with the passive array 1190 of the tag 1160 by touching a particular location on the outer surface of the tag 1160. Upon receiving the one or more communication signals 1195-1, and based on the location on the tag 1160 (and corresponding portion of the passive array 1190) being touched by the user 1150, the passive array 1190 shifts the frequency of the communication signal 1195-1 to generate a new communication signal 1195-2. The passive array 1190 can also generate data that is included in the new communication signal 1195-2.

Spatial decoupling of the source devices (e.g., WAC 1185, user devices 1155) and the transceiver of the controller 1104 of an electrical device 1102 can be achieved by the touch of a finger of a user 1150 on the tag 1160. This touch changes the resonance of the passive array 1190 and shifts the frequency of the communication signal 1195-2 received by a controller 1104 of an electrical device 1102 from the passive array 1190 of the tag 1160. The new communication signals 1195-2 are sent (e.g., backscattered) by the tag 1160 to one or more of the electrical devices 1102 using communication links 1105. This bistatic architecture configuration of FIG. 11 can be suitable for any of a number of situations. For example, the configuration of FIG. 11 can be suitable for existing electrical devices 1102 and/or other components of the system 1100.

Since the communication signals 1195-2 transmitted by the tag 1160 can include control instructions and status indicators, the bit rate of the communication signals 1195-2 can be reduced relative to other communication signals transmitted in the current art. By reducing the bit rate of the communication signals 1195-2 transmitted by the tag 1160, the broadcast range (e.g., broadcast range 882) of the communication signals 1195-2 can be increased, and the sensitivity of these communication signals 1195-2 can also be increased.

The amount of power used by the passive array 1190 of the tag 1160 described can be negligible (e.g., microwatts), and so no power source is required by the tag 1160. Instead, energy from the incoming communication signals 1195-1 can be utilized by the passive array 1190 to generate and backscatter the communication signals 1195-2. Also, since carrier sensing is not required, self-interference of the communication signals 1195-2 is mitigated.

For the system 1100 of FIG. 11, there is no need for a continuous wave source, which would send continuous communication signals 1195-1 to the tag 1160. Also, the firmware of the communication module (e.g., communication module 108) or other appropriate component of the controller 1104 of the electrical devices 1102 for communication protocols such as BLE may need to be modified to maintain LUT so that communication signals 1195-2 backscattered by the tag 1160 can be demodulated properly by the controller 1104.

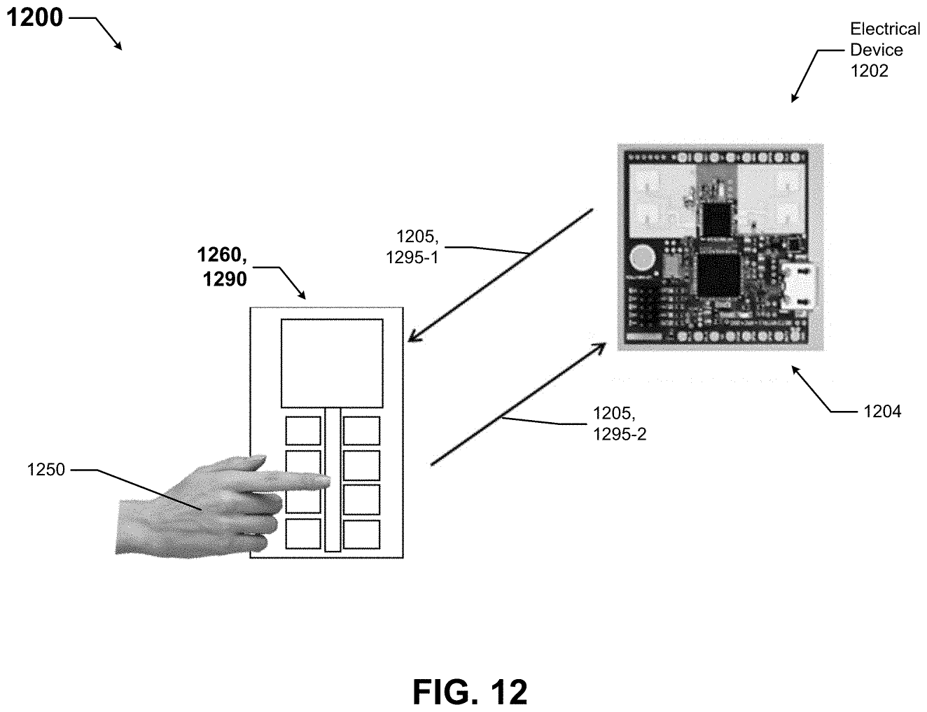

FIG. 12 shows a diagram of another system 1200 in accordance with certain example embodiments. Referring to FIGS. 1 through 12, the system 1200 of FIG. 12 includes an example tag 1260 with a passive array 1290 and an electrical device 1202 with a controller 1204. The controller 1204 can send communication signals 1295-1 in the form of mm-wave radar. Millimeter wave (mm-Wave) is a special class of radar technology that uses short wavelength electromagnetic (EM) waves. Radar systems (such as the controller 1204 of electrical device 1202) transmit communication signals 1295-1 in the form of EM wave signals. When the tag 1260 is in the path of these communication signals 1295-1, they are backscattered by the passive array 1290 of the tag 1260, becoming communication signals 1295-2.

With the configuration of the passive array 1290 of the tag 1260, the frequency of the communication signals 1295-2 is different from the frequency of the communication signals 1295-1. By capturing the reflected communication signals 1295-2, the controller 1204 of the electrical device 1202 can determine one or more pieces of information, including but not limited to an instruction in the communication signals 1295-2, the distance between the tag 1260 and the electrical device 1202, the velocity of the communication signals 1295-2, and position of the tag 1260 relative to the electrical device 1202.

In certain example embodiments, for the system 1200 of FIG. 12, the controller 1204 (or portion thereof) may need to have its firmware updated or modified to maintain LUT, as the LUT can contain a frequency shift in the communication signals 1295-2 that can otherwise be misinterpreted relative to the desired function as selected by the user 1250 on the tag 1260.

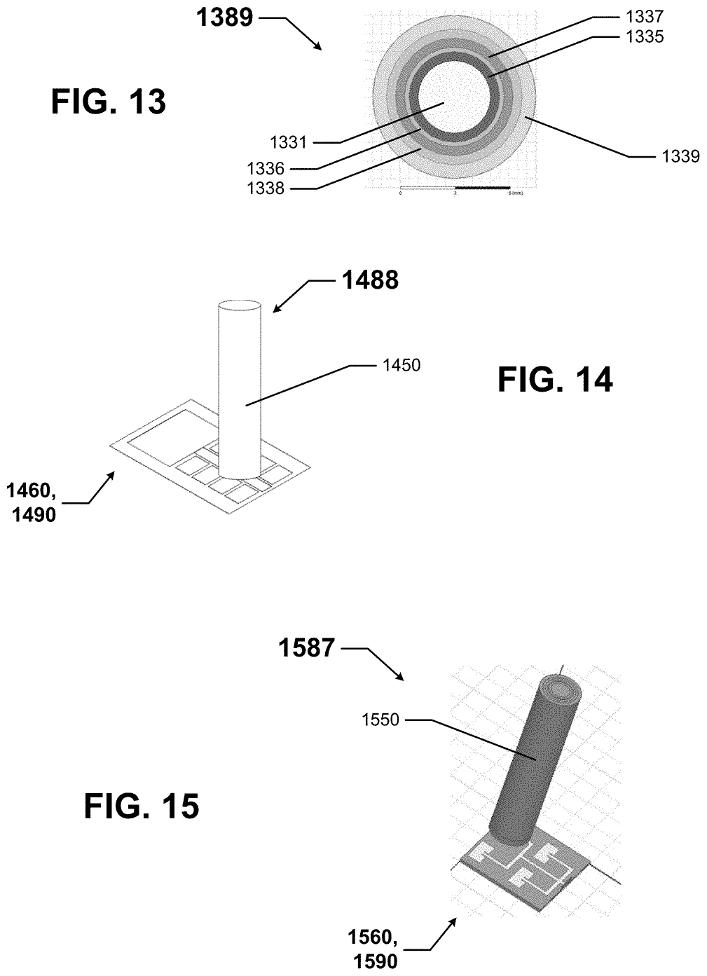

FIGS. 13 through 15 show examples of how the touch of a user on a tag can backscatter communication signals to one or more electrical devices in accordance with certain example embodiments. FIG. 13 shows a cross-section 1389 of a finger of a user. FIG. 14 shows part of a system 1488 that illustrates an interaction between a finger of a user 1450 and a passive array 1490 of a tag 1460 with a bistatic architecture in accordance with certain example embodiments. FIG. 15 shows part of another system 1587 that illustrates an interaction between a finger of a user 1550 and a passive array 1590 of a tag 1560 with a unistatic architecture in accordance with certain example embodiments.

Referring to FIGS. 1 through 15, the cross-section 1389 of a finger of a user (e.g., user 150) has a number of elements. In this case, those elements, from the center and moving outward, include bone 1331, blood 1335, fat 1336, muscle 1337, nerves 1338, and skin 1339. While the cross-section 1389 of FIG. 13 shows a series of concentric circles representing these elements, models can be arranged to show a more real-life cross-section of a human finger, including non-circular shapes, mixtures of elements, and addition/omission of certain elements.

The cross-section 1389 is meant to be a representation of a finger of a user. Since different elements have varying conductivity and/or other parameters (as shown in the table below), such modeling can be important to determine what part of the tag (and so also the corresponding portion of the passive array) is intended to be contacted by the finger (or other body part or object (e.g., stylus)) so that the communication signal sent by the tag is interpreted correctly by a receiving controller of an electrical device.

| | Conducitiv- | | | Wave- | Penetra- |
|---|---|---|---|---|---|
| | ity | | Tan | length | tion |
| Elements | (S/m) | Er | (delta) | (m) | (m) |
| Blood | 2.5024 | 58.34 | .3212 | 0.0161 | 0.0164 |
| Bone | 0.3846 | 11.41 | .2524 | 0.0366 | 0.0469 |
| Fat | 0.1023 | 5.285 | .1450 | 0.0541 | 0.1195 |
| Muscle | 1.705 | 52.79 | .2419 | 0.0170 | 0.0227 |
| Nerve | 1.068 | 30.19 | .2649 | 0.2253 | 0.0275 |
| Skin | 1.44 | 38.06 | .2835 | 0.0200 | 0.0229 |

These values for the different elements can be calculated, measured, and/or otherwise determined. For example, Cole-Cole fitting equations can be used to calculate the values listed in the table above. The various values for the elements shown in the table above can be frequency specific. A controller (e.g., controller 104), network manager (e.g., network manager 180), and/or other component of a system (e.g., system 100) can use one or more algorithms (e.g., algorithms 133) to establish and/or update one or more parameters associated with contacting a passive array (e.g., passive array 190) so that communications signals backscattered by an example tag are interpreted correctly.

With respect to the part of the system 1488 of FIG. 14, a finger of a user 1450 is contacting a tag 1460 (and so also a passive array 1490) at a particular point. Based on the known characteristics of a finger of a user 1450, as discussed above with respect to FIG. 13, the controller of an electrical device that receives a communication signal backscattered by the tag 1460 can determine which TP on the tag 1460 the user 1450 is contacting, and thereby determine or confirm the instruction that the controller should follow. The following table shows results of a simulation for the part of the system 1488 of FIG. 14.

| Description | S11 @ 2.43 GHz (dB) | Delta-F (MHz) |
|---|---|---|
| No touch | −21 | 0.0 |
| TP1 | −9 | 10 |
| TP2 | −5.4 | 20 |

With respect to the part of the system 1587 of FIG. 15, a finger of a user 1550 is contacting a tag 1560 (and so also a passive array 1590) at a particular point. Based on the known characteristics of a finger of a user 1550, as discussed above with respect to FIG. 13, the controller of an electrical device that receives a communication signal backscattered by the tag 1560 can determine which TP on the tag 1560 the user 1550 is contacting, and thereby determine or confirm the instruction that the controller should follow. The following table shows results of a simulation for the part of the system 1587 of FIG. 15.

| Description | S11 @ 24 GHz (dB) | F (GHz) |
|---|---|---|
| No touch | −5.5 | 22.5 |
| TP | −6 | 23.1 |

In one or more example embodiments, a tag with a passive array can allow for the control of one or more electrical devices without the need for a power source or hardware dedicated to a communication protocol (e.g., BLE). The passive array of an example tag can backscatter a communication signal sent by another device in a system. If there is interaction with the passive array (e.g., a finger of a user contacts a touch point), then the communication signal backscattered by the example tag can have one or more different characteristics (e.g., different frequency) that can provide for an instruction, an identification, and/or any other suitable component of the communication signal. Example tags can be located in any of a number of places in a system, can have a very low profile, can be flexible, can be wearable, can be stationary or mobile. Using example embodiments described herein can improve communication, safety, maintenance, costs, and operating efficiency.

Accordingly, many modifications and other embodiments set forth herein will come to mind to one skilled in the art to which example embodiments pertain having the benefit of the teachings presented in the foregoing descriptions and the associated drawings. Therefore, it is to be understood that example embodiments are not to be limited to the specific embodiments disclosed and that modifications and other embodiments are intended to be included within the scope of this application. Although specific terms are employed herein, they are used in a generic and descriptive sense only and not for purposes of limitation.

What is claimed is:

1. A passive tag for communication, the passive tag comprising:
a passive array comprising an antenna assembly and at least one resonator coupled to the antenna assembly; and
a body that covers the passive array, the body comprising at least one touch point, wherein each of the at least one touch point corresponds to one of the at least one resonators of the passive array,
wherein the body and the passive array are without a power source,
wherein the body and the passive array are further without a transistor,
wherein the passive array is configured to receive a first communication signal, and
wherein the passive array is further configured to backscatter a second communication signal using the first communication signal.

2. The passive tag of claim 1, wherein the body and the passive array are further without hardware to support a communication protocol.

3. The passive tag of claim 1, wherein the body is made of a flexible material.

4. The passive tag of claim 1, wherein the passive array comprises at least one electrically-conductive material.

5. The passive tag of claim 1, wherein the first communication signal has a first frequency, and wherein the second communication signal has a second frequency when the at least one touch point is contacted by an object.

6. The passive tag of claim 5, wherein the object is a finger of a user.

7. The passive tag of claim 5, wherein the second frequency of the second communication signal corresponds to the at least one touch point when the at least one touch point is contacted by the object.

8. The passive tag of claim 1, wherein the first communication signal is received from a first electrical device, and wherein the second communication signal is backscattered to a second electrical device.

9. The passive tag of claim 1, wherein the first communication signal is received from an electrical device, and wherein the second communication signal is backscattered to the electrical device.

10. The passive tag of claim 1, wherein the second communication signal is addressed to an electrical device.

11. The passive tag of claim 1, wherein the second communication signal comprises an identification of the passive tag.

12. A system comprising:
a first electrical device comprising a first controller, the first controller comprising a transmitter for sending a first communication signal generated by the first controller; and
a passive tag comprising a passive array and a body, the passive array comprising an antenna assembly and a first resonator coupled to the antenna assembly, the body covering the passive array, the body comprising a first touch point, wherein the first touch point corresponds to the first resonator of the passive array,
wherein the passive tag is without a power source,
wherein the passive tag is further without a transistor,
wherein the passive array receives the first communication signal, and
wherein the passive array backscatters a second communication signal using the first communication signal.

13. The system of claim 12, wherein the second communication signal is received by a receiver of the first controller of the first electrical device.

14. The system of claim 12, wherein the second communication signal is received by a receiver of a second controller of a second electrical device.

15. The system of claim 12, further comprising:
an object that contacts the first touch point when the passive array receives the first communication signal, wherein the first communication signal has a first frequency, wherein the second communication signal has a second frequency that is based on the object contacting the first resonator through the first touch point.

16. The system of claim 12, wherein the passive tag is further without hardware to support a communication protocol.

17. The system of claim 12, wherein the first communication signal is transmitted using Zigbee.

18. The system of claim 12, wherein the first communication signal is transmitted using Bluetooth.

19. The system of claim 12, wherein the first communication signal is transmitted using Bluetooth Low Energy.

20. The system of claim 12, wherein the passive array further comprises a second resonator, and wherein the body further comprises a second touch point that overlays the second resonator.
